(19) United States
(12) Patent Application Publication
(10) Pub. No.: US 2017/0051122 A1
(43) Pub. Date: Feb. 23, 2017

(54) COATED FOAM METHOD AND APPARATUS

(71) Applicant: PETER CARDELL, GRAND PRAIRIE, TX (US)

(72) Inventor: PETER CARDELL, GRAND PRAIRIE, TX (US)

(21) Appl. No.: 15/308,051

(22) PCT Filed: Apr. 30, 2015
(86) PCT No.: PCT/US15/28664

§ 371 Date: Oct. 31, 2016

Related U.S. Application Data
(60) Provisional application No. 61/986,862, filed on Apr. 30, 2014.

(51) Int. Cl. C08J 9/36; C08J 9/32

(52) U.S. Cl. CPC C08J 9/365; C08J 9/32; C08J 2205/052; C08J 2205/05; C08J 2201/038; C08J 2375/04; C08J 2475/04

(57) ABSTRACT

The present application includes a foam product having a foam member with one or more cavities below a surface of the foam member. A dry fill material is located within the one or more cavities to the level of the surface of the foam member. A coating material is applied to the combined foam member and dry fill material. The coating material is permitted to pass around the dry fill material and fill the one or more cavities. The coating material infusing to the foam member within throughout the one or more cavities.

### TECHNICAL FIELD

The present application relates generally to flexible coatings, more particularly, to a new process of applying a coating to a variety of foam substrates.

### DESCRIPTION OF THE PRIOR ART

There are many types of foams readily available for purchase today. In some cases, the foam is provided as a shape which has been cut from a larger shape. As a result of the cutting process, the surface of the cut foam piece is irregular in that the cells on the surface have been cut open. This is true of both open-cell and closed-cell foam. Because of this irregular surface condition, challenges exist in applying a coating directly to the foam surface in a way that results in complete coverage with a smooth exterior surface.

Some solutions lie in the use of a material (e.g. other foams, fabrics, etc.) that is adhered to or fused to the surface of the main foam substrate. Adhering the foams or fabrics attempt to mitigate the irregular “cut-cell” surface but require additional materials (i.e. the material itself) and additional processing steps in applying and bonding the material prior to coating.

Another solution sometimes used involves the use of a liquid coating. However, liquid coatings will tend to be absorbed into the foam thereby returning the foam to an irregular “cut-cell” surface condition. This includes both intermediary coatings (e.g. primers) as well as possible final coatings (e.g. paint, polyurethane, etc.). Applying several layers of primers and/or outer coatings can eventually result in a smooth outer surface, but this approach has several drawbacks: (1) the multiple layers of primer/coating would make the effort cost-prohibitive in terms of the coating costs; (2) the labor expense required for allowing the multiple layers to dry as the layers are built up would tend to add to significant labor costs; (3) keeping the work product in a paint booth for that extended time would incur opportunity costs in terms of other paint jobs waiting to go into the booth; (4) each layer of coating adds additional weight to the foam member resulting in significant weight gains in the final product; and (5) each layer would make the end product less flexible. An additional disadvantage of liquid primers is that they may diminish the adhesive strength of the desired final outer coating with respect to the underlying foam substrate. The result would be a higher likelihood that the coating would separate itself from the foam substrate prematurely.

Some of the most common visible results of a coating that does not completely cover the underlying foam are pinholes. These pinholes are usually caused by the ongoing absorption of the coating into the foam substrate. In the case of applying some two-part coatings, the exothermic reaction (heating up) of the coating can cause small air pockets (defects) in the underlying substrate to heat up and cause undesirable pinholes and/or bubbles in outer coating.

Although great strides have been made in the area of coating foam substrates, considerable shortcomings remain.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is an enlarged side section view of a coated foam product according to the preferred embodiment of the present application;

FIG. 2 is an exemplary side section view enlarged having a coating material of the coated foam product dispersed within dry fill material; and

FIG. 3 is a chart of the process of manufacturing the coated foam product of FIG. 1.

While the apparatus and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various elements and to the spatial orientation of various aspects of elements as the product is depicted in the attached drawings. However, as will be recognized by those skilled in the art after a complete reading of the present application, the elements, members, apparatuses, etc. described herein may be positioned in other desired orientation. Thus, the use of terms, such as above and below, to describe a spatial relationship between various components or to describe the spatial orientation of aspects of such components should be understood to describe a relative relationship between the elements or a spatial orientation of aspects of such elements, respectively, as the product described herein may be oriented in any desired direction.

The apparatus and method in accordance with the present application overcomes one or more of the above-discussed problems commonly associated with conventional foam coating methods and products. Specifically, the apparatus and method of the present application combines the use of dry fill materials to fill the cavities of the foam member that develop along the surface after cutting of the foam member. The dry fill materials are used to create a level surface for the application of a coating material. The coating material is applied to the foam member and the dry fill material in one or more steps. The curing of the coating material raises the temperature of the dry fill material sufficient to cause the dry fill material to infuse to the foam member. A bond is created between the dry fill material, foam member, and coating material. Many advantages are realized as noted herein.

A particular feature of the present application is the fact that no glues, overlaying fabric, or liquids are used. The coating material is provided with a substrate of dry fill material that when infused, strengthens the foam product, increases heat insulative properties and increases the audio insulative capability of the foam product. The dry fill material allows the coating material to be minimized yet provide a pinhole-free finish. These and other unique features of the system are discussed below and illustrated in the accompanying drawings.

The apparatus and method will be understood, both as to its structure and operation, from the accompanying drawings, taken in conjunction with the accompanying description. Several embodiments of the apparatus and method may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

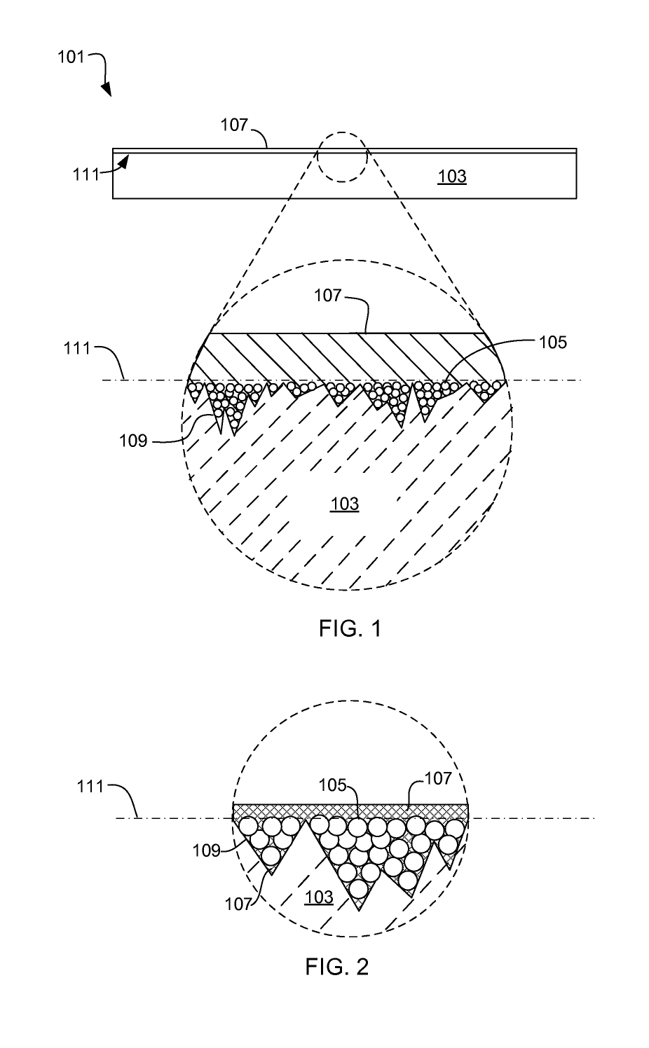

The foam product of the present application is illustrated in the associated drawings. Referring now to the drawings, wherein like reference characters identify corresponding or similar elements in form and function throughout the several views. In FIGS. 1 and 2, enlarged side section views of a foam product 101 are illustrated. Foam product 101 includes a foam member 103, a quantity of dry fill materials 105, and a coating material 107. An advantage of foam product 101 is that dry fill material 105 replaces the need to use solvents, adhesives, sealers, or other liquid substrates and bonding agents to create the level surface or bond with coating material 107 and foam member 103. Coating material 107 in FIG. 1 illustrates a representative example of coating material 107 in a pre-cured state as initially applied. Whereas FIG. 2 is used to illustrate coating material 107 in representative post cured state.

Foam member 103 is selectively shaped having one or more sides at some relative orientation to one another. One or more of the sides have been subjected to cutting so as to form the selected shape. Upon cutting the cells of the foam member 103 are exposed creating one or more cavities 109. Cavities 109 are small depressions along a surface 111 of foam member 103. Each cavity 109 extends below the surface 111. Such cavities 109 present an uneven surface for the application of coating material 107 and may lead to undesired surface traits in the final product, such as pinholes. It is understood that cavities 109 may be created by the cutting of different types of foam. Foam member 103 may include closed cell foam and/or open cell foam. Both types of foam encounter similar issues of cavities 109 when cut and shaped.

Dry fill material 105 is located within cavity 109 and distributed across a designated portion of the surface 111 that will receive coating material 107. Material 105 is configured to provide a suitable substrate for the application of coating material 107. In application, cavities 109 are filled such that the dry fill material 105 is leveled with the relative surface 111 of foam member 103. In other words, dry fill material 105 is evenly distributed across surface 111 sufficiently to fill cavities 109 and avoid excess accumulation of material 109 from passing above surface 111.

Dry fill material 105 is also configured to permit the selectively bonding or infusion of foam member 103 and coating material 107. Coating material 107 is applied through one or more application steps across the surface 111 of foam member 103. Dry fill material 105 and foam member 103 act to provide a relatively level surface to create an even and pinhole-free surface of coating material 107. Coating material 107 is distributed in an even layer configured to make contact with both foam member 103 and dry fill material 105. Coating material 107 is configured to work its way around dry fill material 105 within each cavity 109 by passing between individual materials 105 and/or material 105 and member 103. Some dry fill material 105 are enveloped within the underlying part of coating material 107 while other material 105 remain within the foam member 103 below an inner surface of the coating material 107. This is best seen in FIG. 2, in an enlarged exemplary view to show coating material 107 between and around dry fill materials 105. In FIG. 2, the coating material 107 has had a time to disperse within cavities 109 prior to curing. Therefore the thickness of coating material 107 above surface 111 is less in FIG. 2 than seen in FIG. 1.

Coating material 107 is applied in a liquid state, while the resulting final state is a compliant flexible solid state. An exothermic reaction occurs during curing of coating material 107 after it is applied to surface 111. While in the liquid state, the shape and size of dry fill materials 105 permit the passage of coating material 107 the pass through down and contact portions of foam member 103 at the base of cavities 109. After curing, coating material 107 is infused with foam member 107 along the length and depth of each cavity 109. Coating material 107 also bonds to dry fill material 105 such that material 105 is secured relative to foam member 103 and coating material 107. The curing of coating material 107 and resulting infusion to foam member 103 forms a strong fully bonded/infused relationship while avoiding difficulties from the production of pinholes at the surface of coating material 107.

Additionally, as evident, dry fill material 105 is also configured to be applied in dry form. Use of a dry material has many advantages over the prior art. As a dry material, there is no need to wait for drying times between layers as seen with liquids. Also, weight is reduced because dry material is not absorbed into foam member 103 as seen with liquids. As a dry fill material, material 105 may be applied rather quickly compared to liquid based materials. Material 105 may be applied as quickly as 1 minute per square foot of foam surface 111. Additionally, handling and clean-up of material 105 is made more simple and less toxic than with conventional liquids, solvents, adhesives, and so forth. This leads to less production time per product and decreased costs.

Dry fill material 105 may be any type of small material. A prime example of a suitable dry fill material is a ceramic microsphere. Material 105 is configured to have a specific gravity less than one (1) so as to minimize any additional weight to the foam product 101 when completed. Additional advantages of product 101 having dry material 105 and coating material 107 as described are: (1) increase of the heat insulative properties of foam product 101; (2) increased audio insulative capability of the foam product 101 such that the transmission of sound through foam member 103 is reduced; and (3) resistance to puncture from external sources is increased.

It is understood that since dry fill material 105 is in fact a dry material the application of material 105 is done on a relatively horizontally oriented surface of foam member 103. It is also understood that coating material 107 may be one of many types of liquefied coatings applied to flexible and compliant surfaces such as foam. An example of coating material 107 is that of a polyurethane material.

Some other key features of foam product 101 are realized. Because dry fill material 105 is used to fill cavities 109 prior to application of coating material 107, a thinner layer of coating material 107 may be applied and yet achieve the same desired trait of a smooth pinhole-free surface. Dry fill material 105 acts to reduce the volume of air within cavities 109. The volume of air therefore does not expand and “pop” through coating material 107 during curing. Reapplication of multiple layers of coating material 107 is not necessary to achieve the desired surface traits. For example, a layer of coating material 107 may be as thin as 30 mils thick and remain pinhole-free. Also, the use of less layering of coating material 107 to achieve the desired surface traits of product 101 results in at least the following: a quicker production time, less drying time, decreased application time for each layer, less overall weight, and a more flexible final product surface, to name a few.

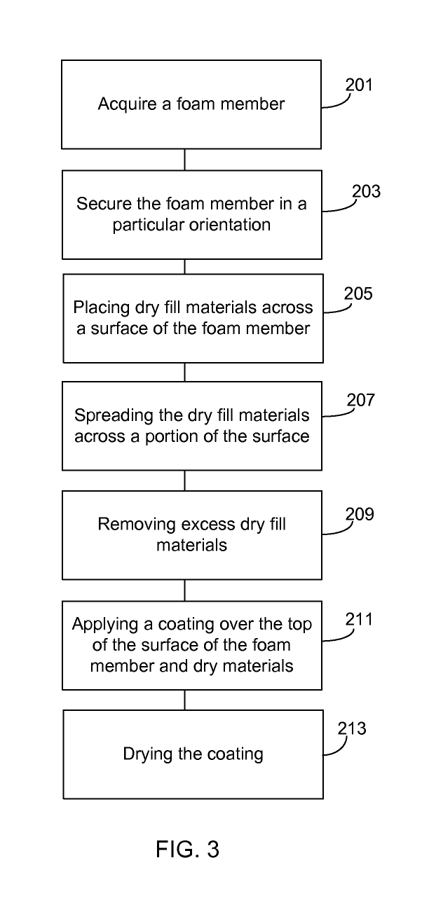

Referring now also to FIG. 3 in the drawings, a chart of the process of manufacturing of foam product 101 is illustrated. A suitable piece of foam is acquired 201. The foam piece may be either open cell or closed cell foam. An example is that of open-cell polyurethane, with 1.8 lbs density and 90 IRD. The foam member is secured 203 in a particular orientation, typically with the surface to be coated in a relatively horizontal position.

Dry fill material is placed 205 across the surface of the foam member and spread 207 as desired so as to achieve a level surface between the foam member and the dry fill material. The dry fill material falls within cavities formed from the cutting and shaping of the foam member. The material is used to provide a level and usable substrate for the application of a coating material. The dry fill material is applied in a solid state and dry such that during the spreading phase it is not bonded to the foam member. Excess dry fill material is removed 209 for reapplication on a second surface of the foam member as necessary.

A coating material is applied 211 along the surface over the top of the foam member and dry fill material. The application of the coating material may be performed in one or more steps/stages. A first stage of applying the coating material may be done by indirect application. A preliminary initial layer may be applied by “dusting” where a fine mist of the coating material is permitted to fall upon the surface under the pull of gravity. In this stage, the coating material is not directly sprayed onto the surface. The dusting preliminary layer is configured to retain the dry fill material within the cavities. The second stage includes the application of a direct spray layer onto the surface. Now that the dry fill material is held by the preliminary layer, a final layer may be directly applied to the surface without fear of removing dry fill materials from the cavities from the pressurized spray. There is no wait time between the initial infusion step and the final application of the outer coating material.

Ideally the coating material maintains a relatively short gel time (cure). It can be as quick as 10-25 seconds. During this time, the chemicals of the coating material experience an exothermic reaction and heat up for a short period and then return to ambient temperatures. It is this exothermic reaction which helps to permit time sufficient for the coating material to pass into each cavity. The coating is permitted to “dry” 213 as necessary. It is understood that curing or drying times may vary depending on the type of coating material and dry fill material used.

The system disclosed within the current application has many advantages over the prior art including at least the following: (1) decreased weight; (2) increase of the heat insulative properties of foam product; (3) an increase in the audio insulative capability of the foam product such that the transmission of sound through foam member is reduced; (4) resistance to puncture from external sources is increased; (5) reduced production times; (6) bonding of fill material occurring at time of application of coating material; and (7) ability to apply the fill material in a dry condition to save time, costs, and risks associated with liquids.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

1. A foam product, comprising:
a foam member having one or more cavities along a surface;
a dry fill material located within the one or more cavities and configured to make the surface of the foam level; and
a coating material applied along the surface to the dry fill material and the foam member;
wherein the coating material is permitted to pass between and around the dry fill material prior to curing and fill the one or more cavities, the foam member being infused to the coating member after curing.

2. The foam product of claim 1, wherein the surface of the foam member includes closed cell foam.

3. The foam product of claim 1, wherein the surface of the foam member includes open cell foam.

4. The foam product of claim 1, wherein the dry fill material is a ceramic microsphere.

5. The foam product of claim 1, wherein the dry fill material is configured to have a specific gravity less than one, so as to add minimal weight to the foam member.

6. The foam product of claim 1, wherein the dry fill material is configured to increase the heat insulative properties of the foam member.

7. The foam product of claim 1, wherein the dry fill material is configured to reduce the audio insulative capability of the foam member, so as to limit the transmission of sound through the foam member.

8. The foam product of claim 1, wherein the dry fill material is configured to increase puncture resistance of the coating material and foam member.

9. A method of applying a coating material to a foam member, comprising:
acquiring a foam member;
securing the foam member in a particular orientation;
placing dry fill materials across a surface of the foam member, the dry fill materials configured to reduce the volume of air within one or more cavities of the foam member;
spreading the dry fill materials across a portion of the surface; and
applying the coating material over the top of the foam material and the dry fill materials, the coating material being permitted to pass through the dry fill materials and fill the one or more cavities;
wherein the coating material and the foam member are infused together throughout each of the one or more cavities.

10. The method of claim 9, wherein the foam member includes closed cell foam.

11. The method of claim 9, wherein the foam member includes open cell foam.

12. The method of claim 9, wherein the dry fill material is a ceramic microsphere.

13. The method of claim 9, wherein the dry fill material is configured to have a specific gravity less than one, so as to add minimal weight to the foam member.

14. The method of claim 9, wherein application of the coating material is independent of dry time.

15. The method of claim 9, further comprising:
removing excess dry fill material for reapplication on a second surface of the foam member.

16. The method of claim 9, wherein application of the coating material includes:
indirectly applying a preliminary layer of the coating material, the indirect application is configured to retain the dry fill material within the cavities; and
directly spraying the a layer of the coating material on the surface of the foam member;
wherein the dry fill material is held within the cavities by the indirectly applied preliminary layer.

17. The method of claim 9, wherein the dry fill material is bonded to the foam member during application of the coating material.

18. The method of claim 9, further comprising:
allowing the combined foam, dry fill material and coating to bond together during curing of the coating material.
